(19) United States
(12) Patent Application Publication
(10) Pub. No.: US 2003/0210340 A1
(43) Pub. Date: Nov. 13, 2003

(54) Camera with a mechanical and electrical interface for couplable engagement with a standard lampholder

(76) Inventor: John Frederick Romanowich, Skillman, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/140,743

(22) Filed: May 7, 2002

(51) Int. Cl. H04N 5/335

(52) U.S. Cl. 348/272

(57) ABSTRACT

A camera having a multifunction interface that is adapted to removably couple the camera mechanically and electrically to a standard lampholder is disclosed. The multifunction interface allows the camera to be installed into the standard lampholder to securely mount the camera in an area of interest. In addition, the multifunction interface receives electrical power from the lampholder to power the camera.

### BACKGROUND OF THE INVENTION

This invention is related generally to surveillance systems, and more particularly to a camera with a mechanical and electrical interface to a standard lampholder.

Surveillance camera systems are commonly used to monitor various areas in places of business, such as parking lots of shopping malls, cashier windows at a bank or gambling tables at a casino. Such systems are becoming more common in home environments too, particularly as home security concerns become more prominent and advances in technology have made equipment less expensive and more compact and capable. In both environments, cameras are mounted in a fixed position in an orientation that provides a view of a surveillance area of interest. Images (and in some applications, sounds) are captured by the camera and relayed to one or more video monitors or recording devices that are typically located in some convenient area. In some systems, the camera includes a motorized mount, adjustable optics or electronics to provide features like tilt, pan and zoom to enable more detailed inspection of a point of interest or to track a moving object or person within the surveillance area.

Difficulty in surveillance system installation is one major disadvantage of conventional surveillance camera systems. More specifically, depending on the application, one or more cameras must be fixedly mounted to a surveillance position such as a building, ceiling, wall, pole and the like. A considerable amount of variability may exist among the physical conditions at these various locations. For example, the materials forming the mounting surface (e.g., metal, wood, wallboard, brick, or siding) as well as the surface orientation and condition (e.g., horizontal, vertical, flat or irregular) may be different at each camera location. In some applications, the camera must be mounted covertly so that it is not readily observable. Because of the myriad of applications for surveillance cameras and the environment in which they must operate, considerable time and effort must be expended to essentially custom make a secure and safe mount for the camera for each application. Fashioning an appropriate camera mount from the wide variety of hardware, brackets, and kits available on the market can be both daunting and expensive for both the professional commercial installer and homeowner alike.

Another drawback with present surveillance camera systems is that both power and signal wiring must be provided to camera. Wiring installation is generally time-consuming, and particularly so when present surveillance cameras are added to existing facilities infrastructure. Careful attention must be paid to ensure that all wiring meets safety codes and is run to minimize electrical and radio frequency interference. In many applications, including those where cameras are installed to monitor remote areas that may be a considerable distance away from the monitoring location. For example for surveillance camera installations in or around parking lots, out buildings, and recreational facilities (e.g., pools, tennis courts), significant costs may be incurred in terms of both wiring materials and wiring installation.

Accordingly, it would be highly desirable to have a camera unit that is easy to install without requiring the installation of new mounting fixtures or wiring.

### SUMMARY OF THE INVENTION

A camera having a multifunction interface that is adapted to removably couple the camera mechanically and electrically to a standard lampholder is disclosed. The multifunction interface allows the camera to be installed into the standard lampholder to securely mount the camera in an area of interest. In addition, the multifunction interface receives electrical power from the lampholder to power the camera.

In an illustrative embodiment, the camera includes an image sensor, for example a solid state sensor such as a charge coupled device (“CCD”) or complementary metal oxide semiconductor (“CMOS”) sensor, for generating an image of a surveillance area. A processing and control circuit is coupled to the image sensor for generating a processed version of the image and controlling the camera's output signal and overall operation. A power supply supplies electrical power to the processing circuit. When the camera is coupled to the lampholder via the multifunction interface, the power supply is electrically coupled to receive power. In addition, the lampholder further acts as a camera mount that physically locates the camera to a desired orientation to thereby register the imaging sensor's field of view to the surveillance area.

In various illustrative embodiments of the invention, a portion of the multifunction interface is provided with a form factor approximating that of a conventional screw-type lamp base. This feature simply and conveniently allows the camera to be screwed into a lampholder just as a conventional lightbulb is installed. The imaging sensor may be attached to the multifunction interface with a variably positionable coupling that allows the imaging sensor to be variably positioned with respect to the multifunction interface. The variably positionable coupling may be motorized in some applications of the invention to provide tilting and panning. The camera's output signal may be relayed to a remote monitoring location using a wireless radio frequency (“RF”) communications path, such as those complying with wireless IEEE 802.11, analog unlicensed radio bandwidth schemes, cellular telephony protocols, or via a power line signal path. The multifunction interface may be configured with an integrated lampholder to receive a standard lamp, such as a light bulb. The camera may be arranged to communicate (either unidirectionally or bidirectionally) over the wireless or power line path so as to receive command signals from a remote controller to control camera operations such as tilt, pan, and zoom or operational status (e.g., on, off, standby) or send status or other information and data signals to the remote location. The integrated lampholder is switchable in response to a command signal received over the communication path or from a local sensor (such as a motion sensor) that may be incorporated into the camera. Other switchable loads, for example, loudspeakers and other output devices, may also be controlled by the camera locally or in response to a remote control signal received over the communication path from a remote location.

Advantageously, the inventive camera may be interfaced with existing lampholders that may already be in place in many applications. For example, many home and business owners have security lighting fixtures installed on poles, in entryways, or affixed to buildings to illuminate exterior areas of buildings, parking lots, or other areas of interest. Such lighting fixtures often utilize one or more spot or floodlights that are positioned with respect the area of interest to provide the desired illumination. The floodlights are typically screwed into lampholders contained in the fixture. In accordance with the invention, the owner may simply remove an existing floodlight and replace it with the inventive camera. Just as the floodlight was previously positioned to illuminate a desired area, once installed in the lampholder, the camera of the present invention becomes conveniently oriented to monitor substantially that same area.

### BRIEF DESCRIPTION OF THE DRAWINGS

FIG. 1 is a simplified pictorial diagram of an illustrative embodiment of a camera with a multifunction interface that is adapted to be removably coupled with a standard lampholder, where the multifunction interface includes a standard lampholder adapted to receive a standard lamp base in accordance with the invention;

FIG. 2 depicts axes describing six degrees-of-freedom of orientation;

FIG. 3 is a simplified end view of an illustrative embodiment of a camera showing the moveable relationship between the camera body and the multifunction interface, in accordance with the invention;

FIG. 4 is a simplified pictorial diagram of an illustrative embodiment of a camera where a camera body is coupled to a multifunction interface with a flexible connector, in accordance with the invention;

FIG. 5 is a simplified pictorial diagram of an illustrative embodiment of a camera where the camera body and multifunction interface are arranged substantially co-axially and the camera body is coupled to the interface with an articulated connector, in accordance with the invention;

FIG. 6 is a simplified pictorial diagram of an illustrative embodiment of a camera where the camera body and interface are arranged substantially co-axially and the camera is coupled to the interface with a flexible connector, in accordance with the invention;

FIG. 7 is a front view of an inventive camera body incorporating a bubble level with respect to a ground plane, in accordance with the invention;

FIG. 8 is a simplified pictorial diagram of an illustrative embodiment of a camera that is mounted in a lampholder contained in a table lamp, in accordance with the invention;

FIG. 9 is a side view of an illustrative embodiment of a camera that is mounted in a lampholder contained in a decorative outdoor light fixture, in accordance with the invention;

FIG. 10 is a front view of the illustrative embodiment of a camera and decorative outdoor light fixture shown in FIG. 9, in accordance with the invention;

FIG. 11 is a simplified functional block diagram of an illustrative embodiment of a camera, in accordance with the invention;

FIG. 12 is a simplified functional block diagram of the bi-directional communications aspect of the invention that utilizes a wireless transceiver, in accordance with the invention;

FIG. 13 is a simplified functional block diagram of the bidirectional communications aspect of the invention that utilizes a power line transceiver, in accordance with the invention;

FIG. 14 is simplified block diagram of an illustrative power supply and multifunction interface, in accordance with the invention;

FIG. 15 is a pictorial representation of an illustrative home surveillance application of the invention utilizing a plurality of inventive cameras, arranged in accordance with the invention;

FIG. 16 is a pictorial representation of an illustrative floodlight fixture in which an inventive camera has been installed; and

FIG. 17 is a simplified diagram of networked application of the invention where a network access point is integrated in the camera.

### DETAILED DESCRIPTION

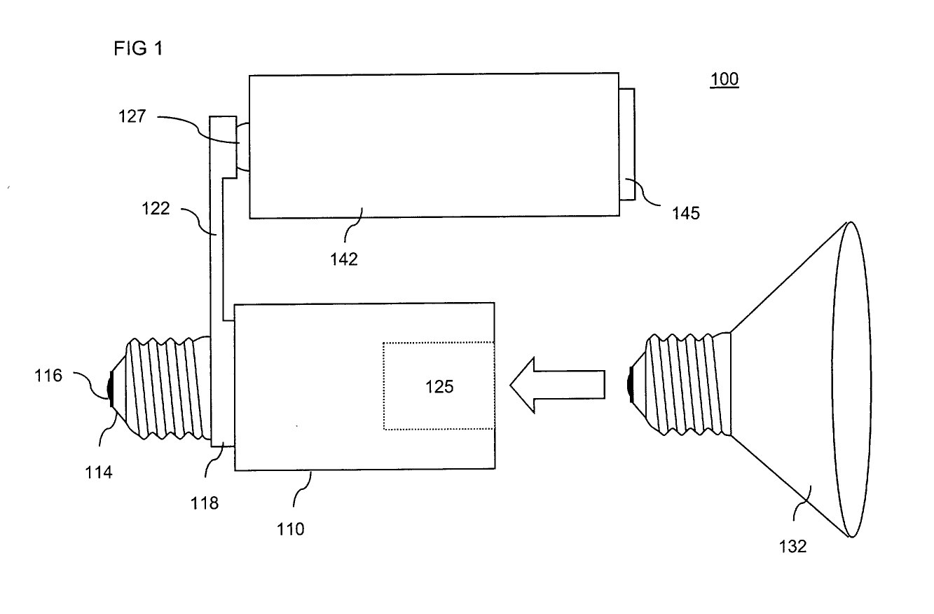

Referring now to the drawings, where like reference numerals refer to the same or similar components across the several views, in FIG. 1, there is shown a simplified pictorial diagram of an illustrative camera 100 with a multifunction interface 110. Multifunction interface 110 is adapted to be removably coupled with a standard lampholder (i.e., the socket in a light fixture in which a lamp, or bulb, is received). Multifunction interface 110 further includes a standard lampholder 125 that is configured to receive a standard lamp 132, as shown in FIG. 1.

Multifunction interface 110 includes a base connector 114 that is configured with the approximate form factor and function of a conventional lamp base. As shown in FIG. 1, the base connector 114 is configured as a screw base. Such screw bases are standardized under American National Standards Institute (“ANSI”) C81.61-1990 and interface with standardized lampholders complying with ANSI C81.62-1991. Screw bases are assigned designations by the International Electrotechnical Commission (“IEC”). Table 1 provides an illustrative, but not an exhaustive, listing of standardized screw bases appropriate for base connector 114 that may be used in practice of the invention.

TABLE 1

| IEC Designation | Description |
|---|---|
| E26/24 | Single-Contact Medium Screw Base |
| E26d | Double-Contact Medium Screw Base |
| E26/50 × 39 | Skirted Medium Screw Base |
| E26/53 × 39 | Skirted Medium Screw Base |
| E39 | Mogul Screw Base |
| E39d | Double-Contact Mogul Screw Base |
| EP39 | Position-Oriented Mogul Screw Base |
| E26 | 3 Contact Medium Screw Base |
| E26 | Medium Screw Base |

It is emphasized that the present invention is not limited to screw bases. Any of a variety of conventional lamp and lampholder combinations may be used as required by the particular application of the invention. For example, base connector 114 may be configured with a form factor that approximates a standard lamp base for interfacing with lampholders using friction-fit, lugs, or mechanical connectors such as screw terminals.

In the illustrative embodiment shown in FIG. 1, base connector 114 includes an single electrical contact 116. When seated in a lampholder in a light fixture (not shown in FIG. 1), the electrical contact 116 contacts a complementary contact in the lampholder to receive AC electrical current. The threaded portion of base connector 114 includes a metallic conductive path to provide the neutral path for the AC current received from the lampholder. Such metallic conductive path may be a discrete conductive element (such as a metallic strip or tab), or a portion or the entire threaded area of the base connector may be composed of a conductive material, for example, aluminum.

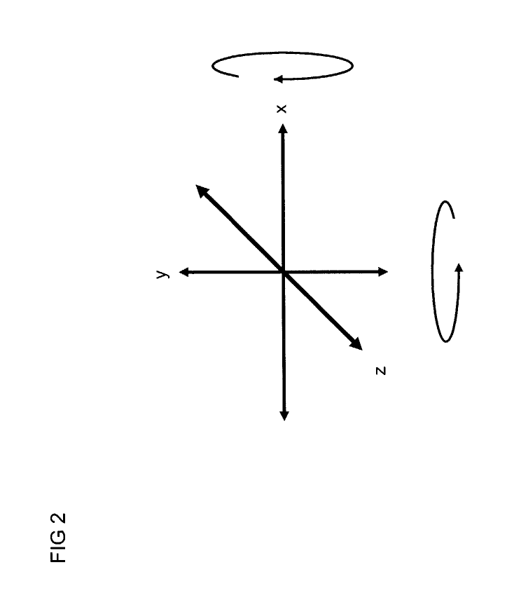

Multifunction interface 110 is coupled to a camera body 142 via a variably positionable coupling 122 as shown in FIG. 1. The variably positionable coupling 122 permits the camera body 142 to be variably spatially oriented with respect to the multifunction interface 110. Generally, up to six degrees of freedom of movement of the camera body 142 relative to the multifunction interface 110 may be desired in applications of the invention. Depending on the application, it may be necessary for camera body 142 to be translated along, or rotated about, each of the x, y and z axes shown in FIG. 2 with respect to a point or plane of reference.

In the embodiment of the invention depicted in FIG. 1, the variably positionable coupler 122 is further arranged to be rotatable about the longitudinal axis of multifunction interface 110 to permit camera body 142 to orbit, in planetary motion, about the longitudinal axis. Accordingly, variably positionable coupler 122 includes a ring portion 118 at its proximal end that is rotatably coupled in an annular arrangement with multifunction interface 110.

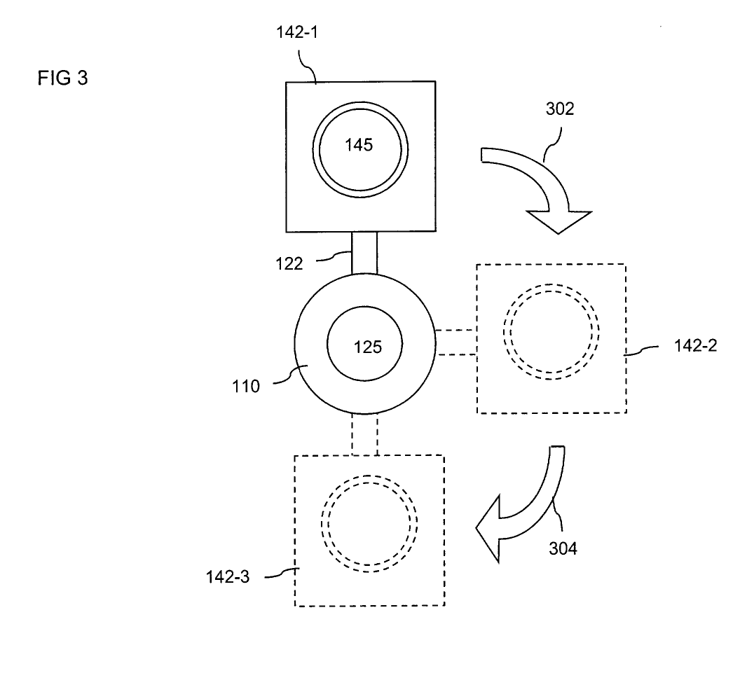

As shown in FIG. 3, camera body 142 may be moved along a clockwise orbital path indicated by arrows 302 and 304. Several illustrative positions on the orbital path, 142-1, 142-2, and 142-3, are indicated in FIG. 3. The variably positionable feature of the invention advantageously allows the camera body to be indexed in a desired position relative to the multifunction interface 110. For example, camera body 142 may take a “12o'clock” position (as indicated by reference numeral 142-1 in FIG. 3) relative to the multifunction interface 110. Similarly, camera body 142 may take a three o'clock position (indicated by reference numeral 142-2) or a six o'clock position (142-3), or any position in between as required by the application. Counterclockwise orbital paths (not shown in FIG. 3) may also be implemented using the variably positionable coupling 122. A user may thus make adjustments to the position of the camera body 142 after the multifunction interface 110 is screwed into a lampholder in a light fixture. The number of turns required to seat the multifunction interface 110 in light fixture's lampholder typically varies from fixture to fixture and such adjustments may be required to position the camera body to a desired orientation.

Referring again to FIG. 1, the variably positionable coupling 122 depicted in this illustrative embodiment of the invention includes a ball and socket joint 127. A ball disposed at the proximal end of the camera body 142 is engaged within a complementary socket at the distal end of variably positionable coupling 122. Camera body 142 may pivot about the ball and socket joint 127 so that the longitudinal axis of the camera body 142 may be positioned in parallel and anti parallel orientations with respect to the longitudinal axis of multifunction interface 110. In addition, camera body 142 may be rotated about its longitudinal axis. Variably positionable coupler 122 includes electrical pathways to supply signal and power connections to an image sensor 145 disposed within the camera body 142.

Image sensor 145 may be selected from a variety of conventional video or still imaging technologies such as solid state devices including charge coupled devices (“CCD”) or complementary metal oxide semiconductor (“CMOS”) sensors that generate an electronic image of a surveillance area. Image sensor 145 may be further selected for infrared (“IR”), near IR, or visible light applications in either monochrome or color configurations.

Image sensor 145 may include optical elements such as lenses (including wide angle and zoom lenses) and filters, depending on the specific requirements of the application. Mechanical elements including shutters and focusing devices may also be incorporated within image sensor 145. Such optical and mechanical elements are not shown in FIG. 1.

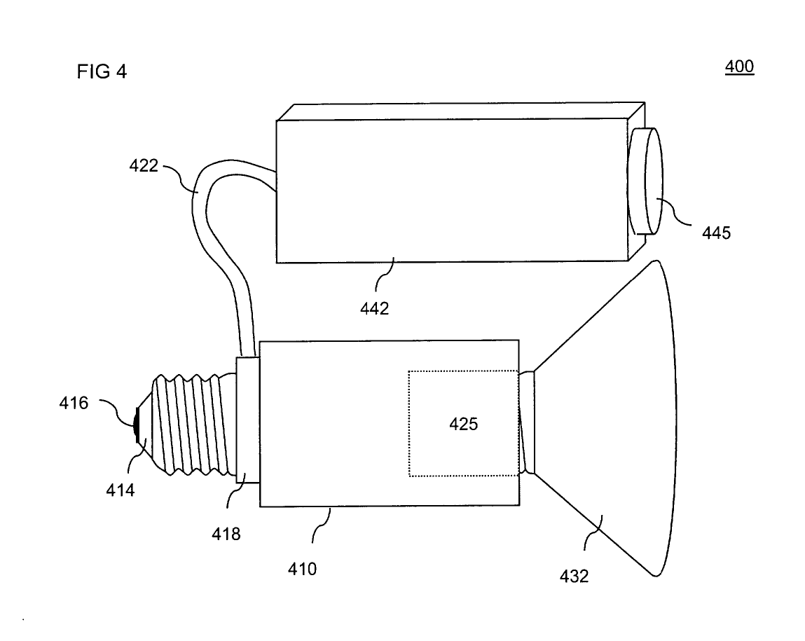

FIG. 4 is a simplified pictorial diagram of an illustrative camera 400 where a camera body 442 is coupled to the multifunction interface 410 with a flexible connector 422, in accordance with the invention. FIG. 4 depicts a light bulb 432 that is fully seated within (i.e., screwed into) a lampholder 425. Lampholder 425 is integrated within multifunction interface 410 and has a conventional form and function. Multifunction interface 410 is similar in form and functionality to multifunction interface 110 in FIG. 1 and includes a threaded base connector 414 and electrical contact 416. Camera 400 includes an image sensor 445 that is disposed at the distal end of the camera body 442.

Flexible connector 422 includes a ring portion 418 that is rotatably coupled in an annular arrangement to multifunction interface 410. A user may thus variably position camera body 442 in an orbital manner with respect to multifunction interface 410, as shown in FIG. 3.

Flexible connector 422 may comprise an articulated “goose neck” arrangement using a flexible and bendable hose made of metal or plastic (or a combination thereof). Such bendable hose material is arranged to substantially retain its shape once bent into a particular desired configurations. Flexible connector 422 may also comprise a flexible and bendable wire (or set of wires) that may double as the electrical pathways required to supply signal and power connections to image sensor 445 (and associated circuitry) disposed within camera body 442. Flexible connector 422 advantageously permits the camera body 442 to take virtually any desired position (i.e., all six degrees of freedom of movement as depicted in FIG. 2 are provided) relative to multifunction interface 410. A user positions the camera body 442 to the desired position and the flexible connector 422 holds the camera body 442 substantially in place.

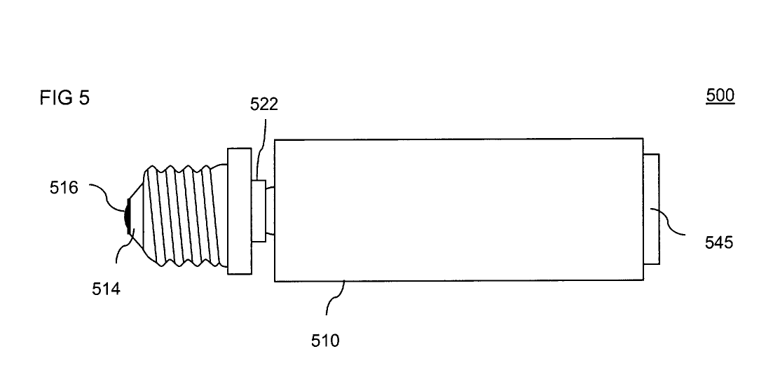

FIG. 5 is a simplified pictorial diagram of an illustrative camera 500 in which a camera body is substantially integrated within a multifunction interface 510. An articulated mechanical connection 522 is used to couple the integrated camera body and multifunction interface 510 to a base connector 514 having an electrical contact 516. In this illustrative embodiment, the mechanical connection 522 comprises a ball and socket joint. An image sensor 545 is disposed at the distal end of the integrated camera body and multifunction interface 510, as shown.

The embodiment of the invention shown in FIG. 5 may be used where no accommodation for a lamp or light bulb is required. There may be instances, for example, where a lampholder in a light fixture provides a convenient mounting and power source for the inventive camera. In such circumstances, the absence of an integrated lampholder in the camera might not be a concern (for example, illumination may be provided by other sources). Alternatively, some light fixtures have provision for more than one lamp or light bulb. Thus, in some applications of the invention, replacing a lamp with the camera 500 still allows a satisfactory level of illumination. In other applications, such as those involving IR surveillance, no visible light source is required at all.

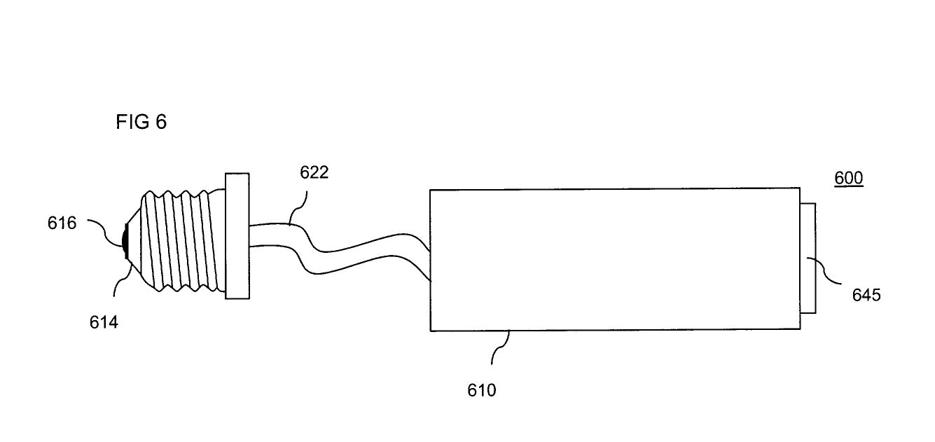

FIG. 6 is a simplified pictorial diagram of an illustrative camera 600 where a camera body is also substantially integrated within a multifunction interface 610. A flexible connector 622 is utilized in this embodiment of the invention to couple the integrated camera body and multifunction interface 610 to a base connector 614 having an electrical contact 616. The flexible connector 622 may be arranged to have a similar form and function to the flexible connector 422 shown in FIG. 4. An image sensor 645 is disposed at the distal end of the integrated camera body and multifunction interface 610, as shown in FIG. 6.

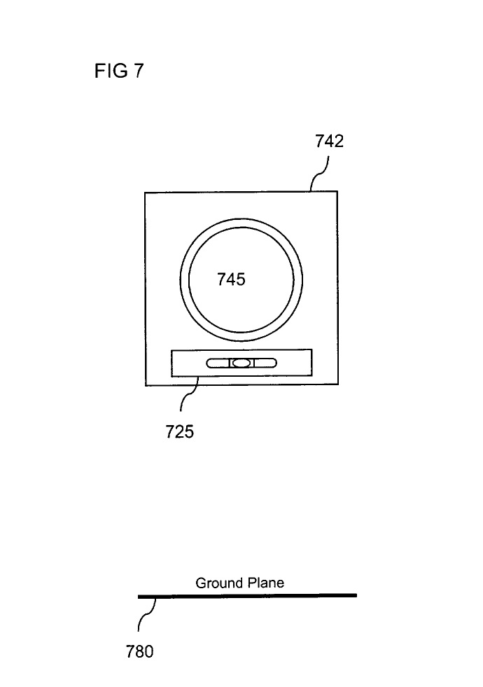

FIG. 7 is a front view of an illustrative camera body 742 that has an image sensor 745, as shown. In this illustrative embodiment of the invention, a conventional bubble level 725 is incorporated in the camera body 742. The bubble level 725 is disposed on the end face of the camera body 742 and is viewable by a user looking towards the end face of the camera body 742. The bubble level 725 readily allows the user to orient the image sensor 745 to be parallel to the plane of the surrounding ground. Such ground plane is indicated by reference numeral 780 in FIG. 7.

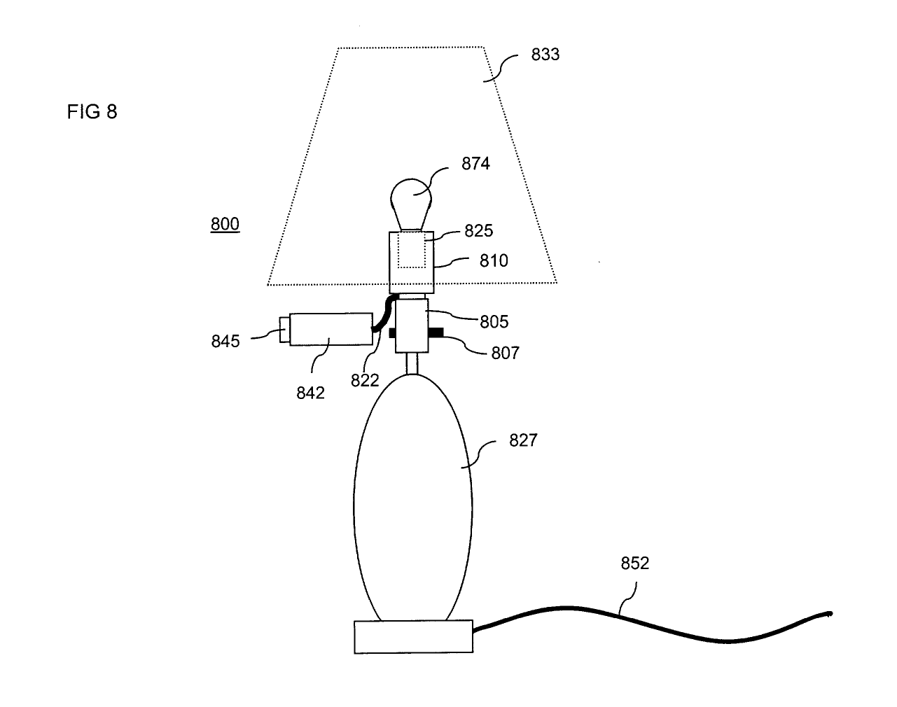

FIG. 8 is a simplified pictorial diagram of an illustrative embodiment of a camera 800 that is mounted to a lampholder 805 contained in a conventional table lamp 827, in accordance with the invention. In this illustrative embodiment of the invention, the camera 800 is similar in form and function to that shown in FIG. 4 and described in the accompanying text.

Camera 800 includes a multifunction interface 810 that is screwed into a lampholder 805 contained in table lamp 827. Lampholder 805 includes a conventional “on-off” push switch 807, as shown. The multifunction interface 810 interfaces with the table lamp's lampholder 805 to both physically mount the camera 800 and also receive electrical power from the table lamp 827. As shown, a standard lamp 874 (i.e., a light bulb) is screwed into a lampholder 825 that is integrated within the multifunction interface 810. Thus, while the camera 800 provides additional features, in accordance with the invention, the table lamp 827 may function to provide illumination in a normal fashion.

Camera body 842 (which has image sensor 845 mounted at its distal end) is coupled to the multifunction interface 810 via a flexible coupler 822, as shown in FIG. 8. The flexible coupler 822 may be similar in form and function to that shown in FIG. 4 and described in the accompanying text.

Power received from the table lamp's standard power cord 852 is routed to the table lamp's lampholder 805 in a conventional manner. Once screwed into the lampholder 805, power is thus coupled through the multifunction interface 810 to the image sensor 845 and associated circuitry in the camera body 842.

As shown in FIG. 8, the camera body 842 is positioned by the user to survey an area of interest, for example, a living area of a home. The image sensor 845 is oriented to the surveillance area while remaining discretely and unobtrusively positioned under the lampshade 833. To an observer, the table lamp 827 appears quite normal with little outward evidence that, using the principles of the invention, it functions to both mount and power a camera.

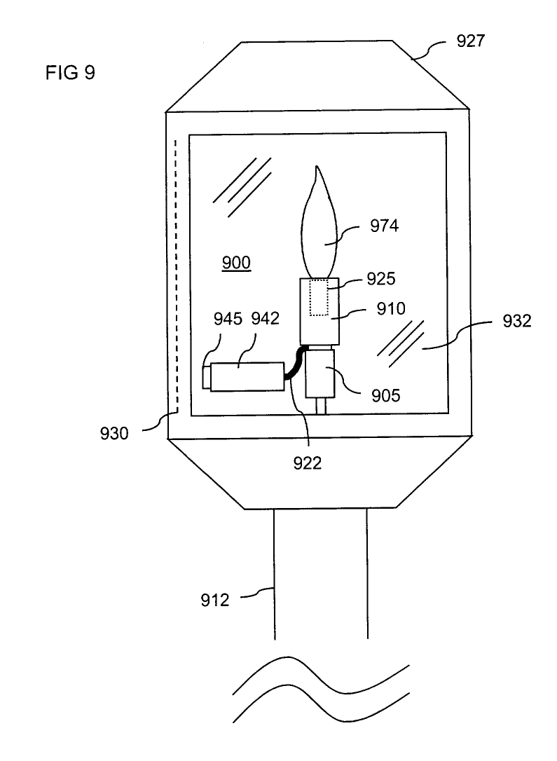

FIG. 9 is a side view of an illustrative embodiment of a camera 900 that is mounted in a lampholder 905 contained in a decorative outdoor light fixture 927, in accordance with the invention. In this illustrative embodiment, the outdoor light fixture 927 is mounted on a post 912 that may be installed in typical outdoor locations such as entryways, walkways, driveways and other areas that require illumination. The camera 900 utilized in this embodiment may be similar in form and function to that shown in FIG. 4 and described in the accompanying text.

The outdoor light fixture 927 is rectangular in plan and includes four glass panes. Two such glass panes are indicated by reference numerals 930 and 932 in FIG. 9. These correspond to glass panes that are located on the left side and front, respectively, of the outdoor light fixture 927 in the view shown in FIG. 9. Such glass panes are typically used in outdoor light fixtures to provide both a measure of weatherproofing to the lamp contained inside, as well as an aesthetic quality. As indicated in FIG. 9, the camera body 942 is oriented so that the image sensor 945 looks through the side glass pane 930 to survey an area of interest.

Camera 900 includes a multifunction interface 910 that is screwed into a lampholder 905 contained in the outdoor light fixture 927. The multifunction interface 910 interfaces with the outdoor light fixture's lampholder 905 to both physically mount the camera 900 and also receive electrical power from the fixture. As shown, a standard decorative candelabra-type lamp 974 is screwed into a lampholder 925 that is integrated within the multifunction interface 910. Thus, as with the embodiment of the invention shown with the table lamp in FIG. 8, in accordance with the invention, the outdoor light fixture 927 may function to provide illumination in a normal fashion.

Camera body 942 (which has image sensor 945 mounted at its distal end) is coupled to the multifunction interface 910 via a flexible coupler 922, as shown in FIG. 9. The flexible coupler 922 may be similar in form and function to that shown in FIG. 4 and described in the accompanying text.

Electrical power is typically provided to the outdoor fixture's lampholder 905 using electrical cable that routed through the interior of post 912 (not shown in FIG. 9) in a conventional manner. Once screwed into the lampholder 905, power is thus coupled through the multifunction interface 910 to the image sensor 945 and associated circuitry in the camera body 942.

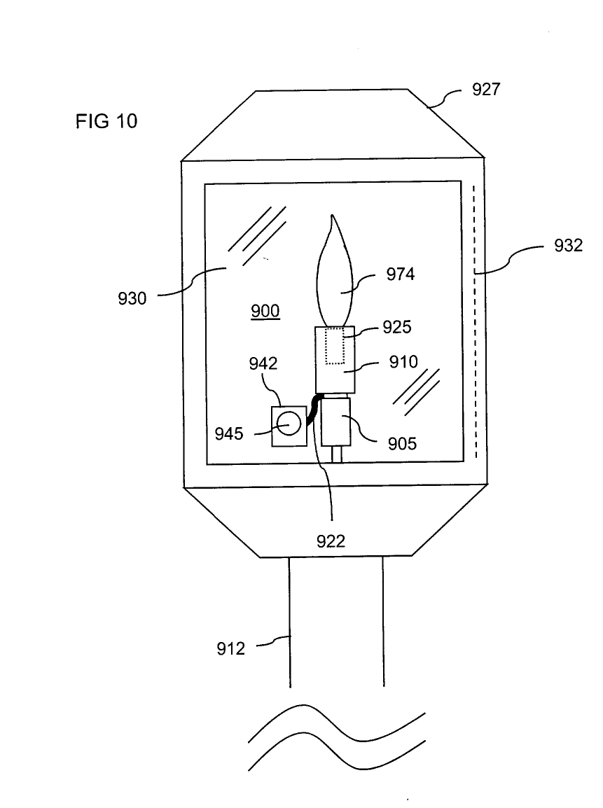

FIG. 10 is a front view of the illustrative camera 900 and decorative outdoor light fixture 927 shown in FIG. 9, in accordance with the invention. As FIGS. 9 and 10 show, the camera body 942 is positioned by the user to survey an area of interest, for example, an entryway, walkway or driveway around a home. The image sensor 945 is oriented to the surveillance area while remaining discretely and unobtrusively positioned in the interior portion of the outdoor light fixture 927 and behind the glass panes. To an observer, the outdoor light fixture 927 does not appear out of the ordinary and shows little outward evidence that, using the principles of the invention, it functions to both mount and power a camera.

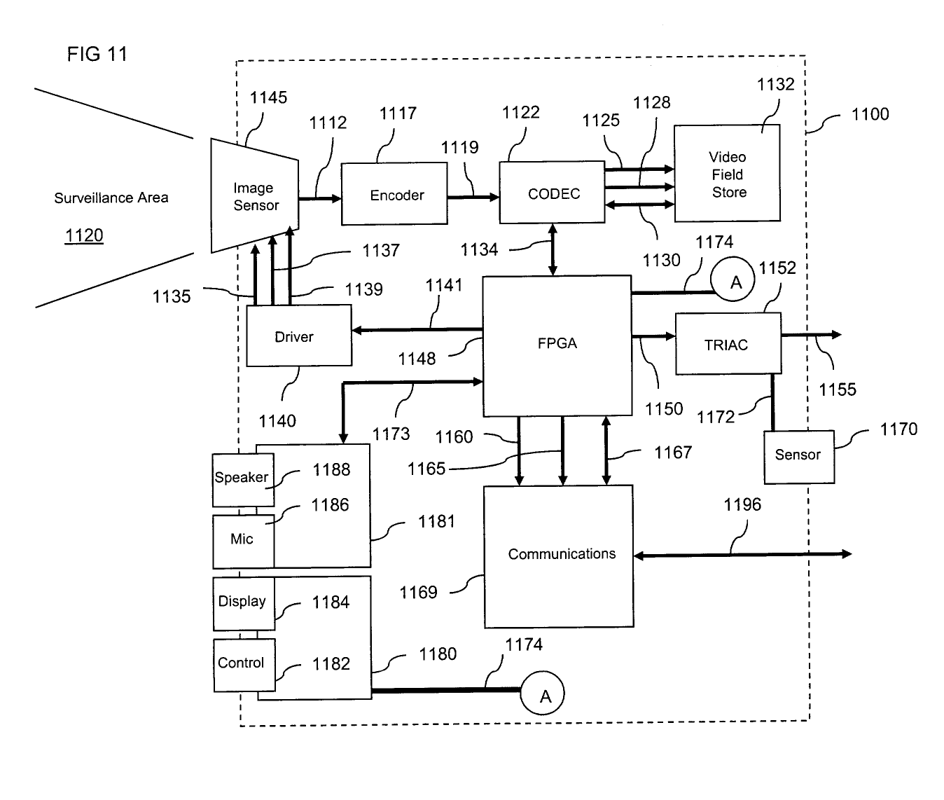

FIG. 11 is a simplified functional block diagram of an illustrative camera 1100, in accordance with the invention. In applications of the invention, the illustrative embodiments of the invention shown in FIGS. 1, 4, 5, and 6 may employ the features and functions shown in the functional block diagram of FIG. 11.

A surveillance area noted generally by reference numeral 1120 is captured by an image sensor 1145. As described above, image sensor 1145 may be selected, for example, from CCD or CMOS sensors. Those skilled in the art will recognize that an audio sensor (such as a conventional microphone) may also be readily incorporated into the camera of FIG. 11 as described below. The audio signal generated by the microphone may be processed in a parallel process to the video image processing that is described in more detail below.

The output signal 1112 from image sensor 1145, which is typically a time-varying stream of analog voltage signals representing the surveyed scene, is coupled to encoder 1117. Encoder 1117 converts the analog signal 1112 from the image sensor 1145 into a digital signal such as a digital component video signal including chromaticity and luminance components. A commercially available encoder such as the SAA7110 or SAA7175 manufactured by Phillips is suitable for many applications of the invention. The output of the encoder 1117 on line 1119 may be compliant, for example, with the Consultative Committee for International Radio (“CCIR”) 601 or 656 video encoding standard. It is noted that the foregoing analog-to-digital conversion is only typically performed with CCD type image sensors as CMOS type image sensors output a digital signal directly.

A CODEC 1122 receives the digital signal on line 1119 and performs compression so that the video image can be represented with fewer data bits. Compression is optionally utilized, depending on the requirements of the specific application, where data transfer between the components and through the camera 1100 is desired to be minimized. For example, in instances where the inventive camera employs a wireless communication path to communicate with a remote monitoring location, bandwidth conservation is more important and greater amounts of signal compression will likely be needed. A CODEC supplied by Analog Devices under part number ADV601 may be suitable in many applications of the invention, including those that require compression ratios as high as 350 to 1. Known compression techniques may be used, in addition to the transformations internal to the ADV601, to achieve such compression where image quality is balanced against both temporal and spatial sub-sampling.

A video field store 1132 is operationally coupled to the CODEC 1122 via communication lines 1125, 1128 and 1130. Video field store 1132 is utilized to store data(and in particular, fields of video), on a temporary basis, utilizing the address and control lines to facilitate the storage and retrieval of video data that is used during the video compression process. Line 1125 is used to send control information to the video field store 1132. Line 1128 is used to send address information to the video field store 1132. Line 1130 is a bi-directional communication line to allow data to be written into and read out of the video field store 1132 by CODEC 1122. Video field store 1132 may be arranged from dynamic random access memory (“DRAM”) for most applications of the invention.

A field programmable gate array (“FPGA”) 1148 (i.e., a programmable logic chip) is operationally coupled to the CODEC 1122 via bi-directional communication line 1134. The FGPA 1148 is the command center of the camera 1100 and controls its functionality and feature set. Generally, the FPGA 1148 provides all the timing signals and logic for implementing the functionalities of the camera 1100. FPGAs suitable for many applications of the invention are supplied by Altera and Xilinx, among others. Those skilled in the art will also recognize that various processing functions may be optionally implemented within the FPGA 1148. For example, in some applications of the invention it may be desirable to implement what is know as “motion-JPEG” type video compression so that the video output by the camera 1100 (and transmitted by a wireless RF or power line communications path) may be conveniently displayed on a personal computer (“PC”) or other device equipped with a standard web browser such as Microsoft Internet Explorer or Netscape Navigator. JPEG stands for the Joint Photographic Experts Group standard, a standard for storing and compressing digital images. Motion-JPEG extends this standard by supporting videos. In motion-JPEG, each frame in the video is stored in the JPEG format.

FPGA 1148 is adapted to receive the compressed video signal generated by CODEC 1122 via bi-directional communication line 1134. FPGA 1148 transmits the compressed video to the communications module 1169 in accordance with timing and control signals generated by the FPGA 1148. Communications module 1169 transmits the compressed video via a wireless RF communications path or power line path to a remote location where it is decoded for display on a monitor or other display device, or may be otherwise saved to a memory such as magnetic tape or optical storage.

FPGA 1148 provides a variably adaptable interface to a communications module 1169. That is, the FPGA 1148 may be adaptable to different communications components depending upon whether the communications module 1169 is configured for wireless radio communication or power line communication. Accordingly, communications module 1169 may take several different forms. For example, communications module 1169 may be selected from Intersil PRISM series wireless local access network (“WLAN”) components to implement a bidirectional wireless RF communication link over path 1196.

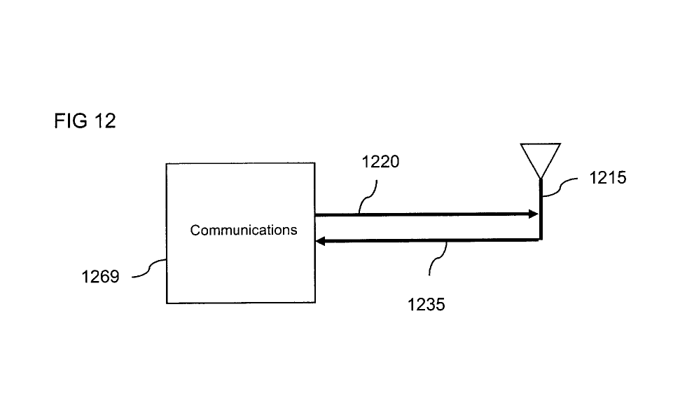

Various wireless RF communications protocols may be alternatively utilized. For example, IEEE 802.11b, IEEE 802.11a, IEEE 802.11g, and other RF protocols may be used depending on the requirements of the application. FIG. 12 shows an exemplary communications module 1269 using such a wireless RF communications protocol. A transmit path 1220 and receive path 1235 are used in conjunction with an antenna 1215 to implement the bi-directional communications path.

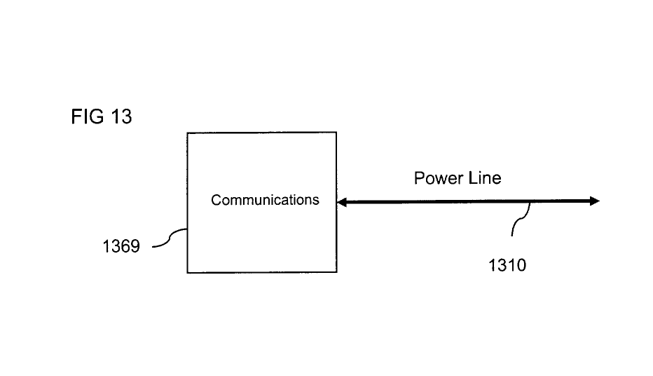

Returning again to FIG. 11, alternatively, communications module 1169 may be selected from Adaptive Networks power line communications (“PLC”) equipment to implement a bi-directional wired communication link via the power supply line (also denoted by reference numeral 1196 in FIG. 11). As shown in FIG. 11, line 1160 is used to send address information to the communications module 1169. Line 1165 is used to send control information to the communications module 1169. Line 1167 is a bi-directional communication line to allow data to be exchanged between FPGA 1148 and the communications module 1169. FIG. 13 shows an exemplary communications module 1369 using such a power line communications protocol and architecture. In this embodiment, a single power line 1310 (which may comprise multiple conductors) is used to implement the desired bi-directional communications path.

Returning again to FIG. 11, Camera 1100 may be arranged to communicate (either unidirectionally or bidirectionally) over the wireless or power line path 1196 so as to receive command signals from a remote controller (not shown in FIG. 11) to control camera operational status. For example, a user at a remote monitoring location may switch the camera on or off, place it in standby mode, or change operating parameters such as video compression rates, image size, resolution, etc. Similarly, the camera 1100 may transmit camera status or other information and data signals to the remote location over communication line 1196 in a bi-directional manner. For example, the camera 1100 may send status information in response to a query from a user.

FPGA 1148 additionally provides a path to reconfigure CODEC 1122 in response to control signals received over the bidirectional communications line 1196. For example, the CODEC's compression ratio may be configured as a user-adjustable parameter that may be set remotely from the monitoring location. Such reconfiguration may be accomplished by appropriate control signals sent from the FPGA 1148 to the CODEC 1122 via bi-directional communication line 1134.

The image sensor 1145 is coupled via a driver 1140 to FPGA 1148. The driver 1140 contains image sensor device drivers to translate the FPGA logic-levels to signals that are usable by the image sensor 1145. Such signals are denoted by reference numerals 1135, 1137 and 1139 in FIG. 11. Note that the image sensor 1145, as described above, is a CCD type image sensor. In those applications where a CMOS type image sensor is utilized, the driver 1140 is not normally necessary.

The FPGA 1148 may be used to operate the image sensor 1145 in modes that may enhance data compression through the CODEC 1122, or to vary the exposure time employed by the image sensor 1145. Such control signals are relayed to driver 1140 via communication line 1141, as shown in FIG. 11.

A triac 1152 is coupled via path 1150 to FPGA 1148. The triac may be used to switch (using line 1155) a powered load, such as a floodlight or other lamp or light bulb, that may be seated in the camera's integrated lampholder (such as lampholders 125 and 425 in FIGS. 1 and 4, respectively). A command or control signal from a remote location may be received over the bi-directional communications path 1196 to implement such switching. For example, a user at a remote monitoring location may send a “light on” command via the bi-directional communications path 1196 (which recall may be either a wireless RF path or a power line path) to the floodlight. Such a command could be in response to video images that are captured by the camera 1100 and transmitted to the remote location for viewing.

The triac 1152 may also be triggered by a locally generated control signal. For example, the FPGA 1148 may include a timing algorithm to turn the floodlight on and off at predetermined times. Or, a local sensor, such as a light sensor 1170 that is coupled to the triac 1152 via signal line 1172, may be used to trigger the triac 1152 according to local conditions. For example, the light sensor 1170 may be used to trigger the triac 1152 to turn the floodlight on at dusk.

The FPGA 1148 may be used in both local and remote triac triggering modes to modify the on and off characteristics of the floodlight very precisely, or in a user-selected manner. For example, the FPGA 1148 may be user-programmed to turn the floodlight (or other electrical load or device) on and off at various times during the course of a week or other time period in accordance with a known activity schedule. The floodlight may also be triggered according to user-defined thresholds as to motion or audio levels captured by the camera 1100. In addition, dimming and other output characteristics of the floodlight may be controlled, for example, by using various pulse width modulation techniques under the control of FPGA 1148.

A user interface 1180 is provided as shown in FIG. 11. The user interface 1180 contains input and output devices such as a display 1184 and control panel 1182. Such display 1184, which may take the form of a liquid crystal panel, for example, can indicate camera operation status, or be used as a graphical user interface (with or without touch screen features) to control user-selected options. The control panel 1182 may take any convenient conventional form include button arrays, keypads (both numeric or alphanumeric) or other pointing and selection devices such as switches, DIP switches, mice, joysticks, trackballs, touchpads, and “eraser head” pointing sticks, for example. As shown in FIG. 11, the user interface 1180 is coupled to the FPGA 1148 via a bi-directional communication line 1174.

A microphone 1186 and speaker 1188 are also provided in an audio interface 1181 to enable bi-directional audio communications between the camera 1100 and the remote monitoring location. For example, a visitor coming to the entryway of a home may be conveniently monitored by the inventive camera 1100 that is installed in an existing light fixture adjacent to the door. When the visitor rings the doorbell to indicate the visitor's presence, the visitor's image is captured by the camera 1100 and relayed via the bi-directional communications path 1196 to the remote monitoring location (somewhere in the interior of the house). A person in the house monitoring the video images (e.g., the homeowner) may then choose to initiate a full duplex audio conversation with the visitor. The homeowner may transmit voice captured by a remote microphone (not shown in FIG. 11) that is relayed to the camera 1100 via bi-directional communications path 1196. The voice signal of the homeowner is played over the speaker 1188 contained in the audio interface 1181. A microphone 1186 may be used to capture audio (i.e., voice) generated by the visitor, and the audio signal relayed via bi-directional communications path 1196 to the remote location, so that a conversation between the homeowner and the visitor may take place. As shown in FIG. 11, the audio interface 1181 is coupled to the FPGA 1148 via a bi-directional communication line 1173.

Those skilled in the art will recognize that enhanced mechanical and optical functionality may be readily implemented in various embodiments of the inventive shown and described above. For example, using the embodiment of the invention shown in FIG. 1 and described in the accompanying text, various motors or actuators may be applied to the variably positionable coupler 122 to mechanically implement tilting and panning of the camera 100. In addition, optical features, such as zooming and panning, may also be accomplished by manipulating the various optical portions of the imaging sensor including lenses and filters. In some applications of the invention, some features such as zoom may be implemented using conventional digital image processing.

The aforementioned mechanical and optical enhancements may be controlled in response to control signals received over the bi-directional wireless communications path 1196 shown in FIG. 11. For example, the camera 100 in FIG. 1 may be tilted and panned in response to control signals generated at a remote monitoring location in order to follow a moving object or person of interest in the area. Similarly, an optical or digital zoom or optical filter may be operated in response to such control signals to enhance the clarity of the image received at the remote monitoring location.

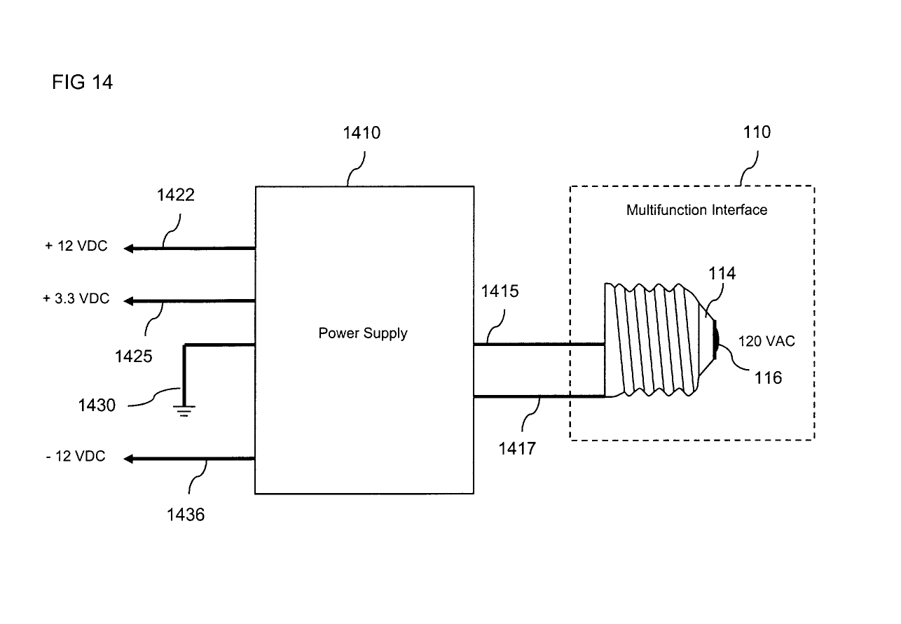

FIG. 14 is simplified block diagram of an illustrative power supply 1410 and multifunction interface 110, in accordance with the invention. Typically the power supply 1410 is disposed in the camera body, for example the camera bodies 110, 410, 510 and 610 shown in FIGS. 1, 4, 5 and 6, respectively. Power supply 1410 typically functions in a conventional manner to convert AC power to lower voltage levels of DC power. Power supply 1410 receives AC electrical power from the multifunction interface (exemplarily illustrated by multifunction interface 110 from FIG. 1), and more specifically from the base 114 that includes a hot contact 116 and neutral contact provided by the metallic base itself. These contacts are coupled, via lines 1415 and 1417, respectively, to the power supply 1410 as shown in FIG. 14. Exemplary power supply output signals are shown at lines 1422, 1425, 1430 and 1436. The actual nominal voltages provided by power supply 1410 will likely vary from application to application. However, as shown in FIG. 14, an exemplary voltage value of +12 VDC is provided at line 1422. Line 1425 provides an exemplary voltage value of+3.3 VDC. A ground is provided at line 1430. Line 1436 provides an exemplary voltage value of −12 VDC with respect to ground.

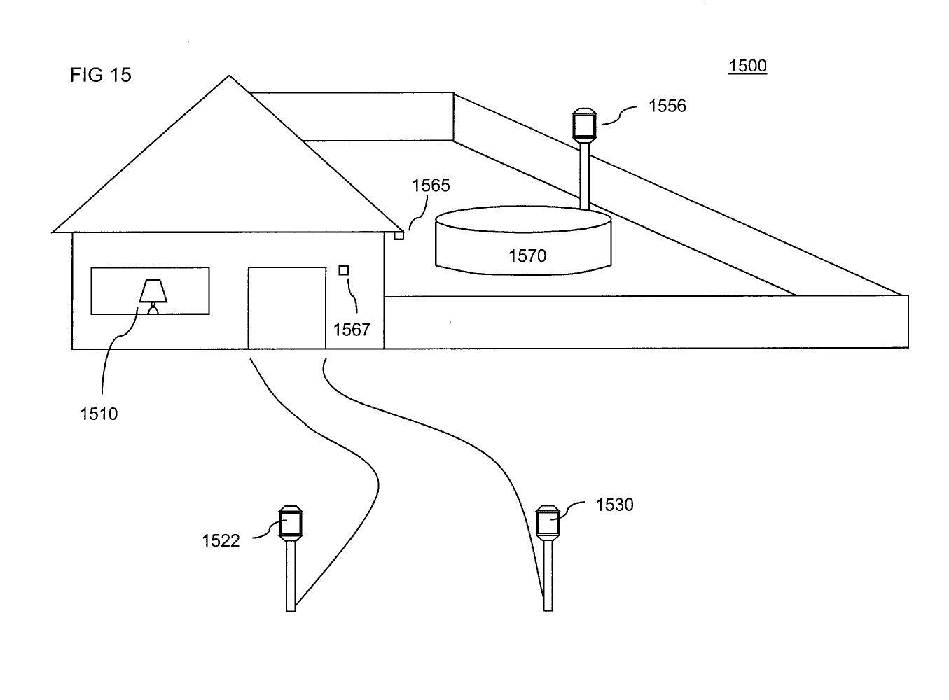

FIG. 15 is a pictorial representation of an illustrative home surveillance application of the invention utilizing a plurality of inventive cameras, arranged in accordance with the invention. It will be recognized that the principles of the invention that are described in the context of the illustrative home surveillance application represented by FIG. 15 may be equally applicable to business and industrial applications as well.

A home 1500 includes an exterior window, doorway, fenced backyard, swimming pool, and driveway, as depicted in FIG. 15. An inventive camera that is similar to that shown in FIG. 8 and described in the accompanying text is located in a table lamp 1510 in the interior of the home. The lamp can be seen through the window at the front of the home. Several inventive cameras that are each similar to that shown in FIG. 9 and described in the accompanying text are located in outdoor light fixtures 1522, 1530, and 1556, as shown in FIG. 15.

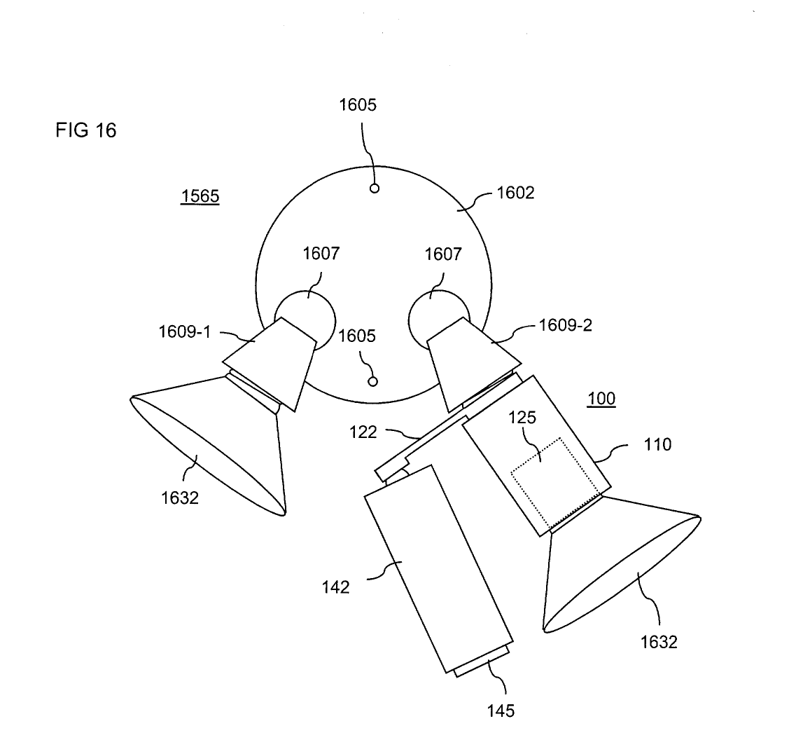

An inventive camera of the type shown in FIG. 1 and described in the accompanying text is installed in a typical floodlight fixture 1565 that is mounted on the eave of the house 1500. FIG. 16 shows a more detailed pictorial representation of such a floodlight fixture 1565. As shown, a mounting flange 1602 contains several through-holes 1605 through which mounting hardware (such as screws) pass in order to surface mount the mounting flange 1602 to a horizontal or vertical surface (such as a wall or eave of a building). A pair of lampholders 1609-1 and 1609-2 are mounted via gimbals 1607 to the mounting flange 1602. Gimbals 1607 are typically utilized to allow the lampholders 1609 to rotate and tilt with respect to the mounting flange 1602. As shown in FIG. 16, the inventive camera 100 that is shown in FIG. 1 and described in the accompanying text is mounted in the right-side lampholder 1609-2. Camera 100 includes a multifunction interface 110 that is operably coupled to the camera body 142 (having an image sensor 145 disposed at its distal end) via variably positionable coupler 122. A standard floodlight lamp 1632 is mounted in the left-side lampholder 1609-1. Another standard floodlight 1632 is mounted in the lampholder 125 that is integrated within multifunction interface 110.

Returning back to FIG. 15, an inventive camera is installed in fixture 1567 located adjacent to the entryway to house 1500. All the cameras depicted in FIG. 15 are typically oriented to cover areas of interest in and around the house 1500. For example, the camera in outdoor light fixture 1522 may be oriented to look back down the driveway, while the camera in outdoor light fixture 1530 may be oriented to look up the driveway of the house 1500. Similarly, the camera in the outdoor light fixture 1556 may be oriented to view the area of the fenced yard and pool 1570, while the camera in the floodlight fixture 1565 monitors the entryway and the camera in the table lamp monitors the interior of the house 1500. The camera in the fixture 1567 is oriented to survey the entryway. More or fewer cameras may be used in other applications of the invention and the cameras shown in FIG. 15 are merely exemplary. Of course, motion-controlled cameras, as described in greater detail above, are also contemplated as being beneficial in certain surveillance applications, including those in home, business and industrial environments.

In accordance with the invention, the cameras depicted in FIG. 15 may communicate in a network configuration over the wireless RF communications path or the power line communications path shown in FIGS. 11-13 and described in the accompanying text. Such networked embodiment of the invention may utilize, for example, wireless Ethernet protocols under IEEE 802.11. A central network controller (not shown) may be used in some applications, but is not necessary in all applications.

The networking of the cameras provides a convenient way to configure and control the plurality of cameras installed in the house 1500 using, for example, a personal computer. Each camera appears to the computer as additional addressable network element. In addition, the computer (or plurality of computers on the network) can be set up to display the surveillance video from one or more cameras on the computer monitor. With the appropriate software, users can choose among views provided by the various cameras for display, or tile multiple views on the monitor. Functions including switching between views automatically (or manually as desired) may be readily accommodated in such networked embodiment of the invention.

In addition to the use of computers to display the video images, the plurality of cameras may be coupled to one or more video converter boxes that can convert the wireless or power line signal into a standard base-band signal that may be displayed on a conventional television set on an unused channel.

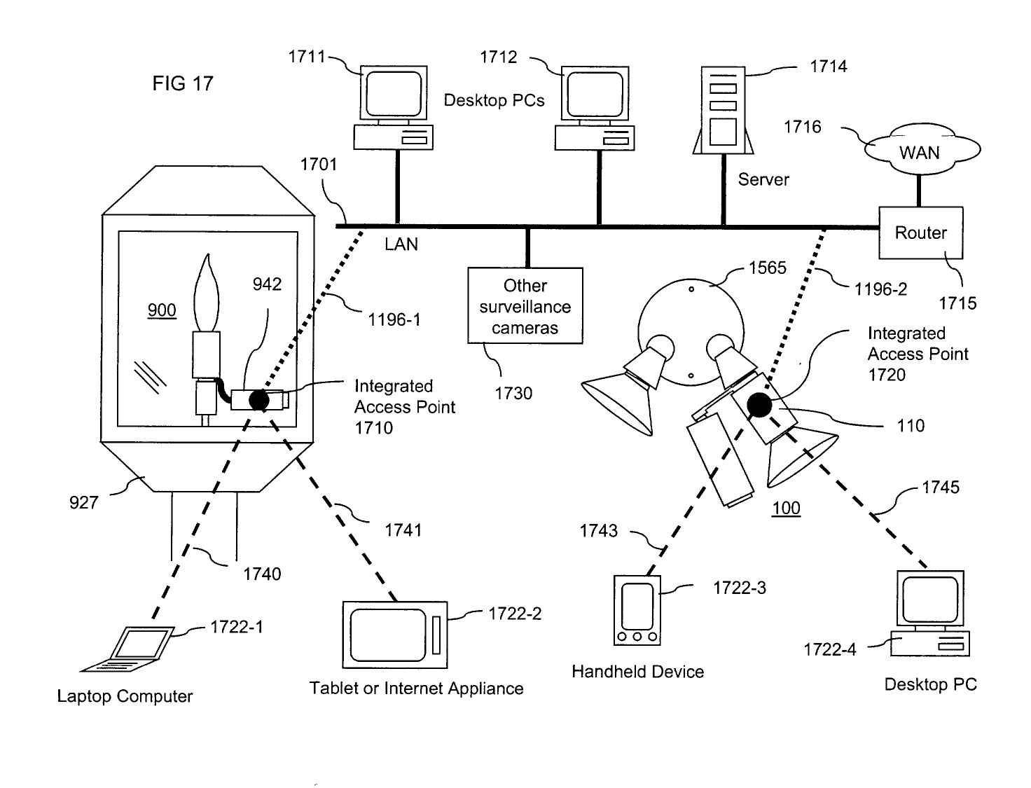

FIG. 17 is a simplified diagram of networked application of the invention where a network access point is integrated in the inventive camera. A network access point is a hardware device having an RF transceiver (and often includes associated firmware or software) that functions as a communications hub for wireless devices to connect to a local area network (“LAN”).

As shown in FIG. 17, a LAN 1701 couples desktop PC 1711 and desktop PC 1712 to a network server 1714. It is noted that PCs 1711 and 1712 and server 1714 are merely illustrative as the principles of demonstrated by this embodiment of the invention may be applied to any of a variety of network configurations and any number of network devices. LAN 1701 may be implemented, for example, using conventional wired or wireless Ethernet networking protocols. A router 1715 provides connectivity between LAN 1701 and a wide area network 1716 (“WAN”) such as the Internet. Conventional peripheral devices (not shown in FIG. 17) may also be connected to the LAN 1701, including printers, scanners, and drives. Other cameras that are arranged in accordance with the invention may also be coupled to LAN 1701 as indicated by reference numeral 1730 in FIG. 17. The LAN 1701 depicted in FIG. 17 would be typical of a network in a home or business.

Access points 1710 and 1720 are integrated in cameras 900 and 100, respectively. As shown in FIG. 17, camera 900 is installed in outdoor fixture 927 while camera 100 is installed in floodlight fixture 1565. Both such fixtures and installation of the inventive cameras are shown in FIGS. 9 and 16 and described in the accompanying text. In the illustrative embodiment of the invention shown in FIG. 17, access point 1710 is integrated within camera body 942 of camera 900 and access point 1720 is integrated within the multifunction interface 110 of camera 100. It is emphasized that this embodiment of the invention is not limited to outdoor fixtures as the network access point feature of the invention may also be advantageously used in indoor applications.

Access point 1710 is coupled to LAN 1701 via bi-directional communications path 1196-1. Either the wireless RF communications methodology (shown in FIGS. 11 and 12, and described in the accompanying text) or the power line communications methodology (shown in FIGS. 11 and 13 and described in the accompanying text) may be used to implement the operative coupling between the access point 1710 and LAN 1701. However, in many applications of the invention, the LAN coupling may be preferably implemented using the wireless RF communications path.

In accordance with the invention, the bi-directional communications path 1196-1 essentially extends the LAN wiring out to the access point 1710. Access point 1720 is similarly coupled to LAN 1720 via bi-directional communications path 1196-2, as shown in FIG. 17. It is noted that the two access points 1710 and 1720 would be typically located in physically diverse locations to extend the reach of the LAN 1701. However, in some applications of the invention, a plurality of access points may be utilized to implemented extended service sets of wireless workstations or multiple subnetworks.

A variety of illustrative wireless devices or workstations are shown in FIG. 17, including laptop computer 1722-1, tablet 1722-2 (which may be an Internet appliance such as a webpad), handheld device 1722-3 and desktop PC 1722-4. All such devices typically use a wireless communications adapter to enable bi-directional wireless communications with the access point or other wireless devices. As shown in FIG. 17, laptop computer 1722-1 communicates with access point 1710 over wireless bi-directional communications path 1740. Tablet 1722-2 communicates with access point 1710 over wireless bi-directional communications path 1741. Handheld device 1722-3 communicates with access point 1720 over wireless bi-directional communications path 1743. Desktop PC 1722-4 communicates with access point 1720 over wireless bi-directional communications path 1745.

Bi-directional communications capability enables what is commonly known as an infrastructure mode of networking. Such networking mode may be compliant, for example, with IEEE 802.11. Thus, by integrating an access point into the inventive camera, an extended network may be implemented whereby the camera functions as a network element as well as a network access point for other wireless devices. In some applications of the invention, the infrastructure networking mode may be used to advantageously enhance, supplement or replace the peer-to-peer (also known as “ad hoc”) communications methodology where wireless devices communicate directly with each other without the need for any intermediate network infrastructure to enable the interaction.

In operation of the illustrative embodiment of the invention shown in FIG. 17, a wireless device 1722 may be used to communicate with any network element on the LAN 1701 and may access the WAN 1715. In addition, ad-hoc communications may be additionally or alternatively implemented in some applications of the invention. Thus, a user at a remote location (such as a backyard, warehouse, etc.) may use a wireless device as a remote monitoring and control workstation for any deployed camera, in accordance with the invention.

For example, referring again to FIG. 15, a user sitting by the pool 1570 may use wireless handheld device 1722-3 to call up the camera 100 which is located in fixture 1565 in ad-hoc mode to receive the video image of the front yard of the house 1500 captured by the camera. In infrastructure mode, the same wireless handheld device 1722-2 may communicate with a camera installed in fixture 1567 (denoted as an “other” surveillance camera 1730 in FIG. 17) that captures video of the front entryway area of the house 1500. In this latter case, wireless handheld device 1722-3 uses the integrated access point 1720 (FIG. 17) in camera 100 to access the LAN 1701 to which the camera in fixture 1567 is coupled. In either ad-hoc or infrastructure mode, the wireless handheld device 1722-3 may communicate bi-directionally with the camera to implement the various video monitoring and control features described in detail above.

Other embodiments of the invention are contained in the claims that follow.

The invention claimed is:

1. A camera adapted to be removably coupled to a lampholder in a light fixture, comprising:
an image sensor for generating an image of an area of surveillance;
a processing circuit coupled to the imaging sensor for generating a processed version of the image;
a power supply coupled to the processing circuit for supplying electrical power to the processing circuit; and
an interface for removably coupling the camera to the lampholder to thereby couple the power supply to power supplied at the lampholder and mount the camera to the light fixture.

2. The camera of claim 1 where the standard lampholder is ANSI-compliant.

3. The camera of claim 1 where the standard lampholder is configured to receive a medium twist lamp base.

4. The camera of claim 1 where the standard lampholder is configured to receive a mogul screw lamp base.

5. The camera of claim 1 where the standard lampholder is configured to receive a double contact medium screw base.

6. The camera of claim 1 where the standard lampholder is configured to receive a skirted medium screw base.

7. The camera of claim 1 where the standard lampholder is configured to receive a double contact mogul screw lamp base.

8. The camera of claim 1 where the standard lampholder is configured to receive a position oriented mogul screw lamp base.

9. The camera of claim 1 where the standard lampholder is configured to receive a 3 contact medium screw lamp base.

10. The camera of claim 1 where the standard lampholder is configured to receive a double contact medium screw lamp base.

11. The camera of claim 1 where the standard lampholder is configured to receive an IEC compliant E26/24 lamp base.

12. The camera of claim 1 where the standard lampholder is configured to receive an IEC compliant E26d lamp base.

13. The camera of claim 1 where the standard lampholder is configured to receive an IEC compliant E26/50×39 lamp base.

14. The camera of claim 1 where the standard lampholder is configured to receive an IEC compliant E39 lamp base.

15. The camera of claim 1 where the standard lampholder is configured to receive an IEC compliant E39d lamp base.

16. The camera of claim 1 where the standard lampholder is configured to receive an IEC compliant EP39 lamp base.

17. The camera of claim 1 where the standard lampholder is configured to receive an IEC compliant E26 lamp base.

18. The camera of claim 1 where the processing circuit comprises a FPGA.

19. The camera of claim 18 further including a CODEC.

20. The camera of claim 1 where a portion of the interface is configured with a form factor approximating a standard lamp base.

21. The camera of claim 1 where the image sensor is disposed in a body and the body and the interface are operably coupled with a variably positionable coupler.

22. The camera of claim 21 where the variably positionable coupler is adapted so that the body may be semi-permanently oriented with up to six degrees of freedom of orientation with respect to the interface.

23. The camera of claim 21 where the variably positionable coupler includes a ball and socket joint.

24. The camera of claim 21 where the variably positionable coupler comprises an articulated hose in a goose neck configuration.

25. The camera of claim 21 where the variably positionable coupler comprises one or more plastically deformable wires.

26. The camera of claim 21 where the variably positionable coupler is coupled in a moveable annular arrangement so as to allow the body to rotate about the interface substantially in planetary motion.

27. The camera of claim 21 where the variably positionable coupler includes motorized portions so that the body may be oriented by a motor in response to received commands.

28. The camera of claim 1 further including a communications module to transmit a signal from the image sensor to a remote location.

29. The camera of claim 28 where the communications module is adapted to transmit the signal using a wireless communication path.

30. The camera of claim 28 where the communications module is adapted to transmit the signal using a powerline communication path.

31. The camera of claim 29 where the wireless communication path is bidirectional.

32. The camera of claim 1 where the interface includes a standard lampholder for receiving a standard lamp.

33. The camera of claim 32 where the standard lampholder is switchable in response to a command signal received by the camera.

34. A method of operating camera having an interface for removably coupling the camera to standard lampholders, the method comprising the steps of:
selecting a fixture having a standard lampholder that is located in an area of interest for surveillance;
coupling the interface to the standard lampholder in the fixture to establish both a mechanical connection between the interface and the standard lampholder and an electrical connection between a power conductor in the standard lampholder and a power contact in the interface;
supplying power to the standard lampholder in the fixture to thereby transmit power to the interface through the electrical connection; and
orienting an image sensor in the camera to the area of interest so that an image of the area may be captured by the image sensor.

35. The method of claim 34 including a further step of transmitting the captured image from the image sensor to a remote location over a communications path.

36. The method of claim 35 where the communications path is a wireless RF path.

37. The method of claim 35 where the communications path is a powerline path.

38. The method of claim 34 including a further step of processing the image captured by the image sensor.

39. The method of claim 38 where the processing includes video compression.

40. The method of claim 34 including the further step of transmitting control signals to the camera over a communications path.

41. The method of claim 40 where the communications path is a wireless RF path.

42. The method of claim 40 where the communications path is a powerline path.

43. The method of claim 40 including the further step of transmitting camera status information to a remote camera-monitoring location.

44. A surveillance camera comprising:
an interface for removably coupling the camera to a standard lampholder disposed in a light fixture to thereby connect the camera to power supplied at the lampholder and further fixedly mount the camera to the light fixture;
an image sensor operably coupled to the interface for capturing an image of a surveillance area; and
a communications module coupled to receive the image from the image sensor for transmitting the image to a remote monitor.

45. The surveillance camera of claim 44 further including an optical assembly disposed on the image sensor.

46. The surveillance camera of claim 45 where the optical assembly comprises a zoom lens.

47. The surveillance camera of claim 45 where the optical assembly comprises a filter.

48. The surveillance camera of claim 44 where the image sensor comprises a CCD sensor.

49. The surveillance camera of claim 44 where the image sensor comprises a CMOS sensor.

50. The surveillance camera of claim 44 further including an image processing circuit.

51. The surveillance camera of claim 44 further including an audio capture device.

52. The surveillance camera of claim 44 further including an audio processor.

53. The surveillance camera of claim 44 further including a triac for switching power to a powered outlet disposed in the surveillance camera.

54. The surveillance camera of claim 53 where the powered outlet comprises a standard lampholder.

55. The surveillance camera of claim 44 further including a user interface.

56. The surveillance camera of claim 55 where the user interface includes a display for displaying camera operating parameters.

57. The surveillance camera of claim 55 where the user interface includes a user input device.

58. A video camera, comprising:
an interface adapted to removably mount the video camera to a standard light socket in a fixture;
an electrical contact disposed in the interface to receive electrical current from the light socket in the fixture; and
an image sensor coupled to the electrical contact for capturing a video image of a surveillance area.

59. The video camera of claim 58 further including a networking module arranged to provide network communications capability to the video camera.

60. The video camera of claim 59 where the network communications capability is compliant with wireless IEEE 802.11

61. The video camera of claim 59 where the network communications capability is enabled via an ad-hoc networking methodology.

62. The video camera of claim 59 where the network communications capability is enabled via an infrastructure networking methodology.

63. The video camera of claim 58 where the image sensor is an IR sensor.
